(19) United States
(12) Patent Application Publication
(10) Pub. No.: US 2024/0219821 A1
(43) Pub. Date: Jul. 4, 2024

(54) LIGHT SOURCE MODULE AND PROJECTOR

(71) Applicant: SONY GROUP CORPORATION, Tokyo (JP)

(72) Inventor: Keisuke HOMMA, Tokyo (JP)

(73) Assignee: SONY GROUP CORPORATION, Tokyo (JP)

(21) Appl. No.: 18/563,323

(22) PCT Filed: Feb. 25, 2022
(86) PCT No.: PCT/JP2022/008060

§ 371 Date: Nov. 21, 2023

(30) Foreign Application Priority Data
Jun. 4, 2021 (JP) 2021-094748

(51) Int. Cl. G03B 21/20; G02B 26/00

(52) U.S. Cl. CPC G03B 21/204; G02B 26/008; G03B 21/2073

(57) ABSTRACT

A light source module according to an embodiment of the present disclosure includes: a light source unit that outputs excitation light; a wavelength conversion unit having a phosphor region and a reflection region, the phosphor region absorbing the excitation light and outputting, as first light, fluorescence that includes light in a wavelength band different from a wavelength band of the excitation light, the reflection region reflecting the excitation light and outputting the excitation light as second light; a wavelength selective polarization separation element that separates light in a predetermined wavelength band on the basis of a polarization direction; and a phase difference element that is selectively disposed in the reflection region and rotates a polarization direction of the excitation light.

### TECHNICAL FIELD

The present disclosure relates to a light source module including, for example, two light valves and a wavelength conversion element as a light source, and a projector including the same.

### BACKGROUND ART

For example, Patent Literature 1 discloses an illumination optical system including: a light source that outputs light of a first wavelength; a phosphor unit; an optical element; and a quarter wavelength plate provided on an optical path between the optical element and the phosphor unit.

### CITATION LIST

### Patent Literature

Patent Literature 1: International Publication No. 2012/127554

### SUMMARY OF THE INVENTION

Incidentally, an enlargement of a color gamut is demanded for a projector that uses two light valves.

Therefore, it is desirable to provide a light source module and a projector that make it possible to enlarge a color gamut.

A light source module according to an embodiment of the present disclosure includes: a light source unit that outputs excitation light; a wavelength conversion unit having a phosphor region and a reflection region, the phosphor region absorbing the excitation light and outputting, as first light, fluorescence that includes light in a wavelength band different from a wavelength band of the excitation light, the reflection region reflecting the excitation light and outputting the excitation light as second light; a wavelength selective polarization separation element that separates light in a predetermined wavelength band on the basis of a polarization direction; and a phase difference element that is selectively disposed in the reflection region and rotates a polarization direction of the excitation light.

A projector according to an embodiment of the present disclosure includes the light source module according to the embodiment of the present disclosure described above.

In the light source module according to the embodiment of the present disclosure and the projector according to the embodiment of the present disclosure, in the wavelength conversion unit having the phosphor region that absorbs the excitation light and outputs the fluorescence as the first light and the reflection region that reflects the excitation light and outputs the excitation light as the second light, the phase difference element that rotates the polarization direction of the excitation light is selectively disposed in the reflection region. Accordingly, the excitation light included in the first light is separated in the wavelength selective polarization separation element.

### BRIEF DESCRIPTION OF THE DRAWINGS

FIG. 1 is a schematic diagram illustrating a configuration example of a light source module according to an embodiment of the present disclosure and a projector including the same.

FIG. 2 is a schematic plan diagram illustrating an example of a configuration of a wavelength conversion unit illustrated in FIG. 1.

FIG. 3 is a schematic cross-sectional diagram illustrating an example of a configuration of a reflection region of the wavelength conversion unit illustrated in FIG. 2.

FIG. 4 is a schematic diagram illustrating another example of a configuration of a quarter wavelength plate illustrated in FIG. 1.

FIG. 5A is a schematic diagram illustrating another example of the configuration of the quarter wavelength plate illustrated in FIG. 1.

FIG. 5B is a schematic diagram illustrating another example of the configuration of the quarter wavelength plate illustrated in FIG. 1.

FIG. 6A is a schematic cross-sectional diagram illustrating another example of the configuration of the reflection region of the wavelength conversion unit illustrated in FIG. 2.

FIG. 6B is a schematic cross-sectional diagram illustrating another example of the configuration of the reflection region of the wavelength conversion unit illustrated in FIG. 2.

FIG. 7 is a schematic diagram illustrating a configuration example of a typical light source module.

FIG. 8 is a diagram illustrating ideal illumination light to be supplied from a light source module to an illumination optical system in a time-sequential manner.

FIG. 9 is a diagram illustrating illumination light to be supplied from the light source module illustrated in FIG. 7 in a time-sequential manner.

FIG. 10 is a schematic diagram illustrating a configuration example of a light source module according to a first modification example of the present disclosure.

FIG. 11 is a schematic diagram illustrating a configuration example of a light source module according to a second modification example of the present disclosure.

FIG. 12A is a schematic cross-sectional diagram illustrating an example of a configuration of a reflection region of a wavelength conversion unit illustrated in FIG. 11.

FIG. 12B is a schematic cross-sectional diagram illustrating another example of the configuration of the reflection region of the wavelength conversion unit illustrated in FIG. 11.

FIG. 12C is a schematic cross-sectional diagram illustrating another example of the configuration of the reflection region of the wavelength conversion unit illustrated in FIG. 11.

FIG. 13 is a schematic diagram illustrating a configuration example of a projector according to a third modification example of the present disclosure.

FIG. 14 is a schematic plan diagram illustrating a configuration example of a wavelength conversion unit in the projector illustrated in FIG. 13.

### MODES FOR CARRYING OUT THE INVENTION

The following describes embodiments of the present disclosure in detail with reference to the drawings. The following description is a specific example of the present disclosure, but the present disclosure is not limited to the following embodiments. In addition, the present disclosure is not limited to arrangement, dimensions, dimensional ratios, and the like of the constituent elements illustrated in the drawings. It is to be noted that the description is given in the following order.

### 1. Embodiment

(An example of a light source module in which a quarter wavelength plate is selectively disposed in a reflection region of a wavelength conversion unit having a phosphor region and the reflection region, and a projector including the same)

### 2. Modification Examples

### 2-1. First Modification Example (Another Example of a Configuration of the Light Source Module)

### 2-2. Second Modification Example (Another Example of the Configuration of the Light Source Module)

### 2-3. Third Modification Example (Another Example of a Configuration of the Projector)

### 1. Embodiment

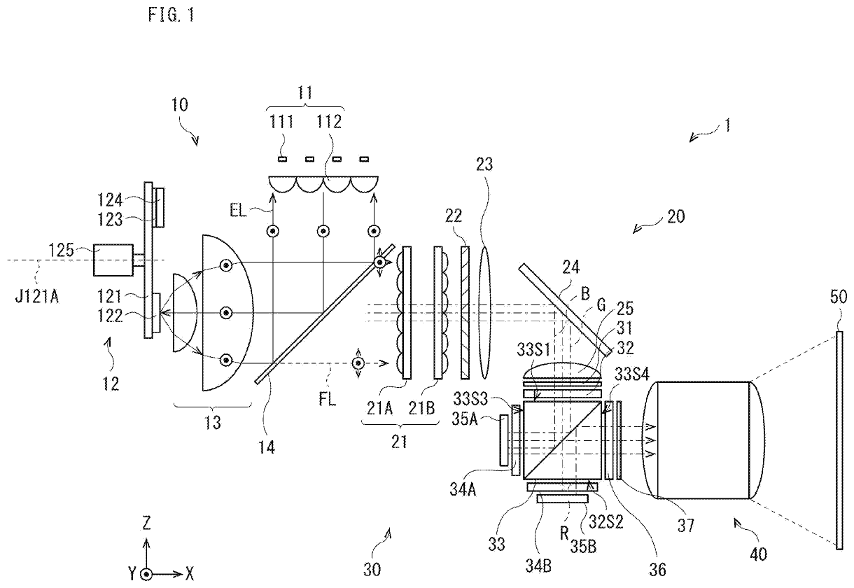

FIG. 1 illustrates a configuration example of a light source module (a light source module 10) according to an embodiment of the present disclosure and a projector (a projector 1) including the same. The projector 1 is a reflection-type 2LCD scheme projection-type display device that performs light modulation using two reflection-type liquid crystal panels (Liquid Crystal Display: LCD). The projector 1 includes, for example, a light source module 10, an illumination optical system 20, an image forming unit 30, and a projection optical system 40.

### [Configuration of Light Source Module]

The light source module 10 includes, for example, a light source unit 11, a wavelength conversion unit 12, a condenser lens 13, a polarization separation dichroic mirror 14, and a quarter wavelength plate 124 that is selectively disposed in a predetermined region of the wavelength conversion unit 12.

The light source unit 11 corresponds to a specific example of a “light source unit” of the present disclosure. The light source unit 11 includes one or a plurality of light sources 111 and a lens 112 disposed to oppose each of the light sources 111. The light source 111 is, for example, a solid-state light source that outputs light of a predetermined wavelength band, and is for exciting phosphor particles included in a later-described phosphor layer 122 of the wavelength conversion unit 12. As the light source 111, it is possible to use, for example, a semiconductor laser (Laser Diode: LD) that outputs S-polarized light or P-polarized light. In addition, a light-emitting diode (Light Emitting Diode: LED) may be used.

From the light source unit 11, for example, light (blue light B) that is polarized to S-polarized light and in a wavelength band corresponding to, for example, blue of a wavelength from 400 nm to 470 nm is outputted as excitation light EL. In the present specification, light in a predetermined wavelength band refers to light having an emission intensity peak in its wavelength band.

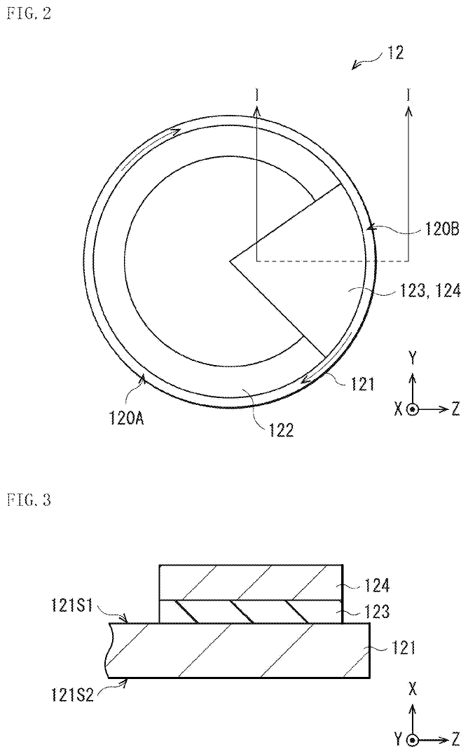

FIG. 2 schematically illustrates an example of a planar configuration of the wavelength conversion unit 12. FIG. 3 schematically illustrates an exemplary cross-sectional configuration of the wavelength conversion unit 12 in I-I line illustrated in FIG. 2.

The wavelength conversion unit 12 corresponds to a specific example of a “wavelength conversion unit” of the present disclosure. The wavelength conversion unit 12 absorbs light (the excitation light EL) entering from the light source unit 11, converts the light into light (a fluorescence FL) having a different wavelength band, and outputs the converted light. The wavelength conversion unit 12 is a so-called reflection-type wavelength conversion device, and is configured to reflect and output the fluorescence FL generated by the incidence of the excitation light EL. The wavelength conversion unit 12 includes, for example, a wheel substrate 121, a phosphor layer 122, a reflection-type polarization maintaining and diffusing plate 123, and a quarter wavelength plate 124. As illustrated in FIG. 2, the wavelength conversion unit 12 has, for example, a phosphor region 120A and a reflection region 120B. The phosphor layer 122 is provided in the phosphor region 120A, and the polarization maintaining and diffusing plate 123 and the quarter wavelength plate 124 are each provided in the reflection region 120B.

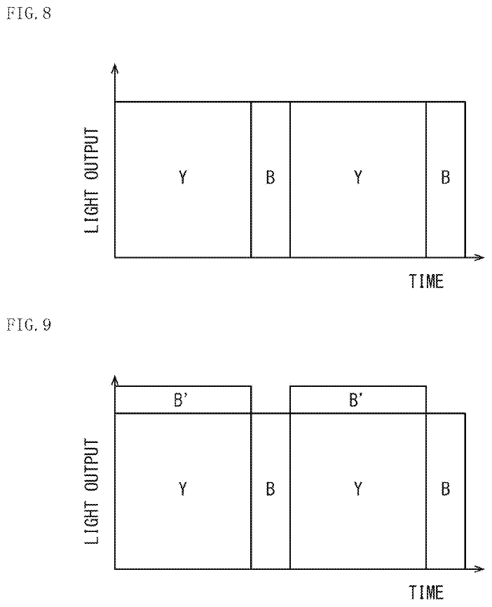

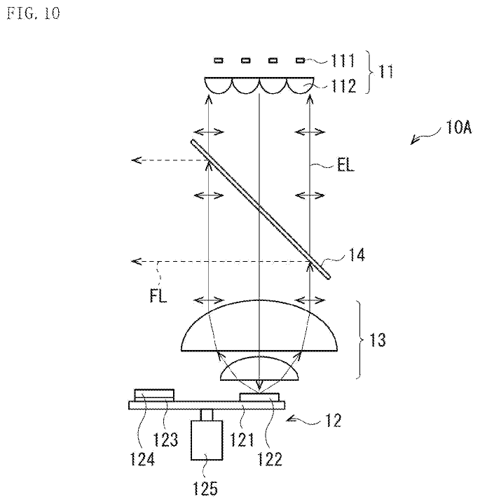

The wavelength conversion unit 12 is, for example, a so-called phosphor wheel that is rotatable about a rotation axis (for example, an axis J121A). In the phosphor wheel, a motor 125 (a driving unit) is coupled to the center of the wheel substrate 121. The wheel substrate 121 is rotatable around the axis J121A by a driving force of the motor 125, for example, in a direction of an arrow illustrated in FIG. 2. In the phosphor wheel, for example, the phosphor layer 122 is continuously formed in a rotational circumferential direction of the wheel substrate 121. The polarization maintaining and diffusing plate 123 and the quarter wavelength plate 124 are so provided as to divide the continuous phosphor layer 122. In the phosphor wheel, when the wheel substrate 121 rotates, an irradiation position of the excitation light EL temporally changes (moves) at a speed corresponding to a rotational speed. As a result, as illumination light from the wavelength conversion unit 12, for example, as illustrated in FIG. 8, a time-averaged white light derived from temporal repetitions of yellow, blue, yellow, blue, and so forth is outputted.

The wheel substrate 121 is for supporting the phosphor layer 122, the polarization maintaining and diffusing plate 123, and the quarter wavelength plate 124. The wheel substrate 121 is, for example, a plate-shaped member having a pair of opposing surfaces (a front surface 121S1 and a back surface 121S2), and has, for example, a disk-like shape. The wheel substrate 121 is, for example, a reflective member and has a function as a heat dissipation member. The wheel substrate 121 may be formed by, for example, a metal material having a high thermal conductivity. Besides, the wheel substrate 121 may include, for example, a metal material or a ceramic material that allows for mirror finishing. This suppresses a temperature increase of the phosphor layer 122 and improves an extraction efficiency of the light (the fluorescence FL) in the wavelength conversion unit 12.

The phosphor layer 122 includes a plurality of phosphor particles, and is excited by the excitation light EL to emit the fluorescence FL in a wavelength band that is different from the wavelength band of the excitation light EL. The phosphor layer 122 is formed in a plate shape by, for example, a so-called ceramic phosphor or a binder-type phosphor. The phosphor layer 122 is provided, for example, in the phosphor region 120A on the front surface 121S1 of the wheel substrate 121. The phosphor layer 122 includes, for example, phosphor particles excited by, for example, blue light B outputted from the light source unit 11 and emit light (yellow light Y) in a wavelength band corresponding to yellow. Such phosphor particles include, for example, an YAG (yttrium-aluminum-garnet) based material. The phosphor layer 122 may further include semiconductor nanoparticles such as quantum dots, organic dyes, or the like.

The polarization maintaining and diffusing plate 123 corresponds to a specific example of a combination of a “light diffusion structure” and a “light reflection layer” of the present disclosure. The polarization maintaining and diffusing plate 123 has no polarization effect on light of a predetermined wavelength band (for example, the blue light B), and has a light reflection property and a diffusion effect. Thus, in the present embodiment, the excitation light EL is outputted from the wavelength conversion unit 12 as a portion of the illumination light (the blue light B). For example, as illustrated in FIGS. 2 and 3, the polarization maintaining and diffusing plate 123 is provided in a fan shape corresponding to a shape of the reflection region 120B, in the reflection region 120B of the front surface 121S1 of the wheel substrate 121.

The quarter wavelength plate 124 corresponds to a specific example of a “phase difference element” of the present disclosure. The quarter wavelength plate 124 converts linearly polarized light into circularly polarized light or circularly polarized light into linearly polarized light, and outputs the polarized light. The quarter wavelength plate 124 is laminated on the polarization maintaining and diffusing plate 123, for example, as illustrated in FIG. 3. As with the polarization maintaining and diffusing plate 123, the quarter wavelength plate 124 is provided in a fan shape, for example, corresponding to the shape of the reflection region 120B, for example, in the reflection region 120B on the front surface 121S1 of the wheel substrate 121. That is, the quarter wavelength plate 124 is selectively provided in the reflection region 120B on the front surface 121S1 side of the wheel substrate 121 via the polarization maintaining and diffusing plate 123. Thus, in the present embodiment, only the excitation light EL applied to the reflection region 120B out of the excitation light EL having entered the wavelength conversion unit 12 is selectively polarized-converted, and outputted toward the illumination optical system 20 to be described later.

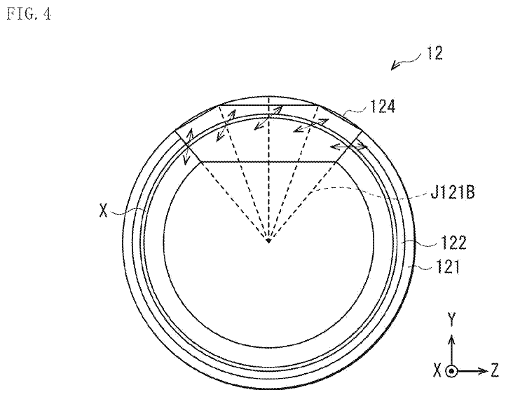

For example, as illustrated in FIG. 4, the quarter wavelength plate 124 may be partially provided in a range, of the reflection region 120B, that includes an illumination trajectory of the excitation light EL. In this case, for example, as illustrated in FIG. 4, it is preferable that the quarter wavelength plate 124 have an outer shape including a straight line. Thus, it is possible to reduce a material cost and a processing cost.

The quarter wavelength plate 124 preferably has a non-uniform slow axis in a plane perpendicular to an optical axis of the excitation light EL. Specifically, for example, as illustrated in FIG. 4, the slow axis of the quarter wavelength plate 124 (an arrow in FIG. 4) preferably has an angle of substantially 45° with respect to a radial axis J121B about the rotational axis J121A in the plane of the wheel substrate 121 (in an XY plane configured by an X-axis direction and a Y-axis direction). Thus, it is possible to improve a polarization conversion-efficiency of the excitation light EL.

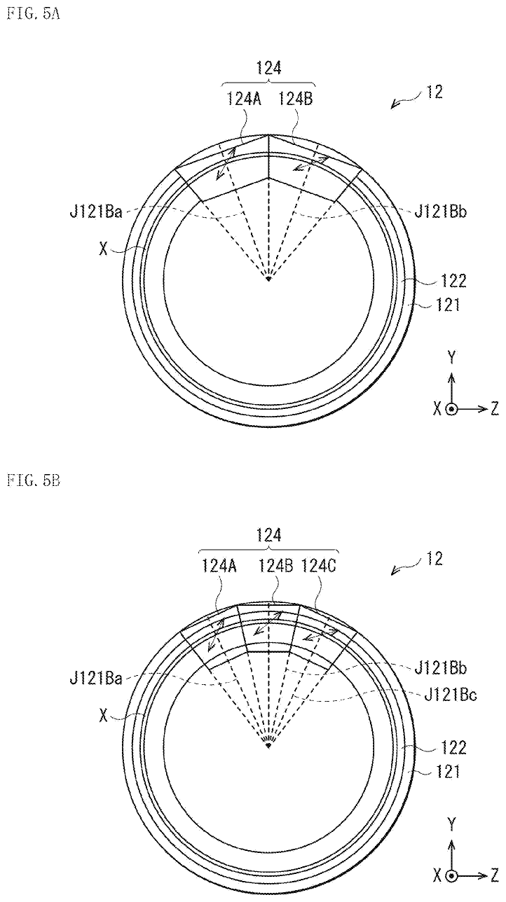

Alternatively, the reflection region 120B may be divided into a plurality of sections with respect to a rotational direction of the wheel substrate 121, and the quarter wavelength plate 124 having a uniform slow axis in a plane perpendicular to the optical axis of the excitation light EL may be provided for each of the sections. Specifically, for example, as illustrated in FIGS. 5A and 5B, the reflection region 120B may be divided into two or three or more sections with respect to the rotational direction of the wheel substrate 121, and quarter wavelength plates 124A, 124B, and 124C having a uniform slow axis in the plane may be provided for the respective sections. The quarter wavelength plates 124A, 124B, and 124C each have a slow axis in a direction of, for example, substantially 45° with respect to the radial axis J121Ba, J121Bb, or J121Bc that passes through the middle of corresponding one of each of the sections. This makes it possible to improve the polarization conversion efficiency of the excitation light EL and reduce a manufacturing cost as compared with a case where the quarter wavelength plate 124 having the non-uniform slow axis in the plane as illustrated in FIG. 4 is used.

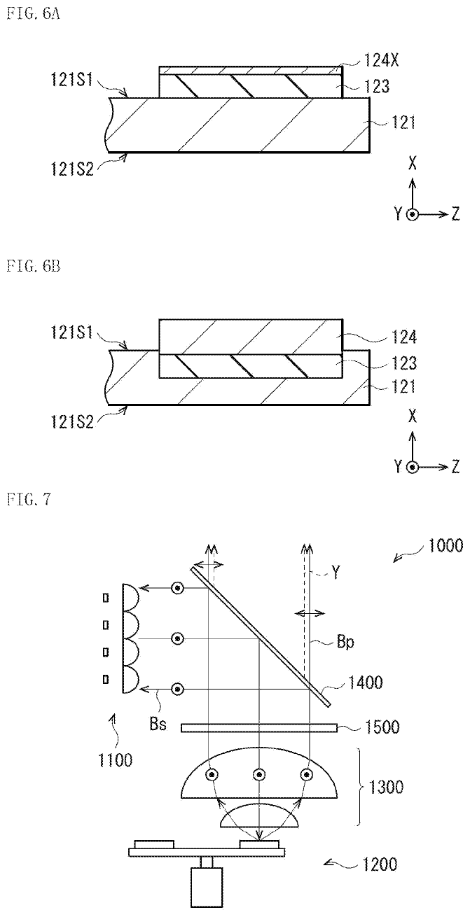

As the quarter wavelength plate 124, for example, a quarter wavelength plate film 124X as illustrated in FIG. 6A may be used besides the plate-shaped member having a predetermined thickness. It is possible to form the quarter wavelength plate film 124X, for example, by vapor deposition or the like. As the quarter wavelength plate film 124X, a quarter wavelength plate film that formable by stretching a film may be used. As a result, it is possible to reduce the number of components to be attached to or coated on the wheel substrate 121 and to reduce a cost. Further, as illustrated in FIG. 3, a rotational balance of the wheel substrate 121 is improved as compared with a case where the polarization maintaining and diffusing plate 123 and the quarter wavelength plate 124 are laminated on the front surface 121S1 of the wheel substrate 121, making it possible to improve flicker. Besides, for example, as illustrated in FIG. 6B, the polarization maintaining and diffusing plate 123 may be embedded in the wheel substrate 121, and the quarter wavelength plate 124 or the quarter wavelength plate film 124X may be attached or coated on a surface thereof. As a result, the rotational balance of the wheel substrate 121 is further improved, making it possible to further improve the flicker.

As the quarter wavelength plate 124, a quarter wavelength plate having a fine periodic structure may be used besides the plate-shaped member and the film-shaped quarter wavelength plate film.

The condenser lens 13 is configured by one or a plurality of lenses. The condenser lens 13 is disposed between the wavelength conversion unit 12 and the polarization separation dichroic mirror 14. The condenser lens 13 condenses the excitation light EL to a predetermined spot diameter and causes the excitation light EL to enter the wavelength conversion unit 12, and converts the fluorescence FL outputted from the wavelength conversion unit 12 into collimated light and guides the collimated light to the polarization separation dichroic mirror 14.

The polarization separation dichroic mirror 14 corresponds to a specific example of a “wavelength selective polarization separation element” of the present disclosure. The polarization separation dichroic mirror 14 separates light in a predetermined wavelength band on the basis of a polarization direction. The polarization separation dichroic mirror 14 selectively reflects, for example, the S-polarized blue light (B). The polarization separation dichroic mirror 14 is disposed between the condenser lens 13 and a lens array 21 to be described later, and is disposed at a position opposed to the light source unit 11. Thus, the S-polarized excitation light EL outputted from the light source unit 11 is reflected toward the wavelength conversion unit 12.

### [Configuration of Illumination Optical System]

The illumination optical system 20 includes, for example, the lens array 21, a PS converter 22, a relay lens 23, a reflection mirror 24, and a field lens 25.

The lens array 21 as a whole has a function of adjusting, to a uniform illuminance distribution, the incident light applied from the light source module 10 to the liquid crystal panels 35A and 35B. The lens array 21 includes, for example, a first fly-eye lens 21A having a plurality of microlenses arranged two dimensionally, and a second fly-eye lens 21B having a plurality of microlenses so arranged as to correspond to the respective microlenses one by one.

The PS converter 22 arranges a polarization state of the incident light in one direction and outputs the thus-arranged incident light. In the projector 1, for example, the PS converter 22 transmits the P-polarized light as it is, and converts the S-polarized light into the P-polarized light. The PS converter 22 is disposed between the lens array 21 and the relay lens 23. The illumination light having transmitted through the PS converter 22 is guided to the field lens 25 via the relay lens 23 and the reflection mirror 24.

The field lens 25 has a function of condensing the illumination light and illuminating the liquid crystal panels 35A and 35B to be described later. The field lens 25 is disposed between the reflection mirror 24 and a polarizing plate 31 to be described later.

### [Configuration of Image Forming Unit]

The image forming unit 30 includes, for example, polarizing plates 31 and 37, wavelength selective polarization rotators 32 and 36, a polarizing beam splitter (PBS) 33, quarter wavelength plate 34A and 34B, and liquid crystal panels 35A and 35B.

The polarizing plates 31 and 37 transmit only linearly polarized light in a specific direction. In the projector 1, the polarizing plates 31 and 37 transmit only the P-polarized light, for example, and reflect the S-polarized light. The polarizing plate 31 is disposed between the field lens 25 and the wavelength selective polarization rotator 32. The polarizing plate 37 is disposed between the wavelength selective polarization rotator 36 and the projection optical system 40.

The wavelength selective polarization rotators 32 and 36 each selectively rotate polarized light in a predetermined wavelength band and output the polarized light. The wavelength selective polarization rotator 32 is disposed between the field lens 25 and a first surface 33S1 of the PBS 33. The wavelength selective polarization rotator 32 transmits light (red light R) in a wavelength band corresponding to red out of the illumination light (for example, the P-polarized light) having entered from the field lens 25 as it is, and converts light (green light G) in a wavelength band corresponding to green and light (blue light B) in a wavelength band corresponding to blue into the S-polarized light and outputs the S-polarized light toward the PBS 33. The wavelength selective polarization rotator 36 is disposed between a fourth surface 33S4 of the PBS 33 and the projection optical system 40. For example, the wavelength selective polarization rotator 36 transmits the red light R (the S-polarized light) outputted from the fourth surface 33S4 of the PBS 33 as it is, and converts the green light G and the blue light B (both P-polarized light) into the S-polarized light. As a result, pieces of image light in which polarization components are arranged are outputted toward the projection optical system 40.

The PBS 33 separates the incident light on the basis of the polarization component. The PBS 33 includes, for example, an optical functional film that reflects or transmits the incident light in accordance with the polarization components, and two prisms that are bonded to each other with the optical functional film interposed therebetween. In the projector 1, the PBS 33 reflects, for example, a S-polarized light component and transmit a P-polarized light component. The PBS 33 has, for example, four surfaces (the first surface 33S1, a second surface 33S2, a third surface 33S3, and the fourth surface 33S4). Out of the four surfaces, the first surface 33S1 and the second surface 33S2 are so disposed as to oppose each other with the optical functional film therebetween, and the third surface 33S3 and the fourth surface 33S4 are so disposed as to oppose each other with the optical functional film therebetween. The third surface 33S3 and the fourth surface 33S4 are disposed between the first surface 33S1 and the second surface 33S2 as surfaces adjacent to the first surface 33S1 and the second surface 33S2. In the present embodiment, the first surface 33S1 is an input surface of the illumination light, and the fourth surface 33S4 is an output surface of the illumination light. The wavelength selective polarization rotator 32 is disposed on the first surface 33S1, and the wavelength selective polarization rotator 36 is disposed on the third surface 33S3.

The quarter wavelength plates 34A and 34B respectively correct the polarization states of the incident light and the output light, and generate a phase difference of approximately ¼ wavelength with respect to light of polarization components orthogonal to each other. The quarter wavelength plate 34A is disposed between the third surface 33S3 of the PBS 33 and the liquid crystal panel 35A. The quarter wavelength plate 34B is disposed between the second surface 33S2 of the PBS 33 and the liquid crystal panel 35B.

Each of the liquid crystal panels 35A and 35B modulates incident light and outputs the modulated incident light, for example, modulates the illumination light on the basis of a picture signal and outputs the modulated incident light. The liquid crystal panel 35A is disposed to oppose the third surface 33S3 of the PBS 33 with the quarter wavelength plate 34A therebetween. The liquid crystal panel 35B is disposed to oppose the second surface 33S2 of the PBS 33 with the quarter wavelength plate 34B therebetween. In the projector 1, the liquid crystal panels 35A and 35B are configured using, for example, reflective liquid crystals.

The projection optical system 40 includes, for example, one or a plurality of lenses. The projection optical system 40 is disposed downstream of the polarizing plate 37, and projects the light modulated by the liquid crystal panels 35A and 35B through the PBS 33 onto a screen 50 as picture light to form an image.

### [Operation of Projector]

In the present embodiment, the blue light (B) mainly containing the S-polarized light is outputted from the light source unit 11 as the excitation light EL, for example, in a Z-axis direction. The excitation light EL outputted from the light source unit 11 is reflected by the polarization separation dichroic mirror 14 toward the wavelength conversion unit 12, for example, in the X-axis direction. The excitation light EL reflected by the polarization separation dichroic mirror 14 first enters the condenser lens 13. The excitation light EL having entered the condenser lens 13 is condensed to a predetermined spot diameter and outputted toward the wavelength conversion unit 12.

Out of the excitation light EL having entered the wavelength conversion unit 12, the excitation light EL applied to the phosphor region 120A excites the phosphor particles in the phosphor layer 122. In the phosphor layer 122, the phosphor particles are excited by the application of the excitation light EL and emit the fluorescence FL. The fluorescence FL is the unpolarized yellow light Y including the S-polarized component and the P-polarized component, and is reflected by, for example, the wheel substrate 121 and outputted toward the condenser lens 13. Out of the excitation light EL having entered the wavelength conversion unit 12, the excitation light EL applied to the reflection region 120B is first converted from the S-polarized light to the circularly polarized light by the quarter wavelength plate 124. Subsequently, the excitation light EL having been converted into the circularly polarized light is reflected and diffused by the polarization maintaining and diffusing plate 123 while maintaining the polarization direction, and is outputted toward the condenser lens 13 via the quarter wavelength plate 124. At this time, the circularly polarized excitation light EL is converted into the P-polarized light. In the wavelength conversion unit 12, as described above, as the wheel substrate 121 rotates, a position at which the excitation light EL is applied is temporally changed (moved) at a speed corresponding to the rotational speed, and the time-averaged white light derived from the temporal repetitions of yellow, blue, yellow, blue, and so forth is outputted as the illumination light.

The fluorescence FL and the excitation light EL outputted from the wavelength conversion unit 12 are each converted into substantially collimated light by the condenser lens 13 and outputted toward the polarization separation dichroic mirror 14. The fluorescence FL enters the polarization separation dichroic mirror without being polarized. At this time, the S-polarized excitation light EL contained in the fluorescence FL and not absorbed by the phosphor particles is reflected toward the light source unit 11. As a result, unnecessary blue light B included in a yellow time zone outputted from the wavelength conversion unit 12 is separated. The fluorescence FL in the unpolarized state and the excitation light EL in the P-polarized state pass through the polarization separation dichroic mirror 14 as the illumination light including the red light R, the green light G, and the blue light B, and enter the lens array 21.

The illumination light outputted from the polarization separation dichroic mirror 14 passes through the lens array 21 and is outputted toward the PS converter 22. In the PS converter 22, the P-polarized component of the unpolarized fluorescence FL is outputted as it is, and the S-polarized component of the unpolarized fluorescence FL is converted into the P-polarized component to be outputted. The P-polarized excitation light EL is emitted as it is. As a result, the polarization state of the illumination light is aligned with the P-polarized light.

The illumination light outputted from the PS converter 22 is guided to the polarizing plate 31 via the relay lens 23, the reflection mirror 24, and the field lens 25. In the polarizing plate 31, a polarized component other than the P polarization component included in the illumination light is blocked, and only the P polarization component is outputted to the wavelength selective polarization rotator 32.

Out of the illumination light that has entered from the polarizing plate 31, the wavelength selective polarization rotator 32 transmits the red light R as it is as the P-polarized light, and converts each of the green light G and the blue light B into the S-polarized light and outputs the converted S-polarized light toward the first surface 33S1 of the PBS 33. The red light R, the green light G, and the blue light B outputted from the wavelength selective polarization rotator 32 are separated by the PBS 33 on the basis of the polarization direction thereof. Specifically, the red light R that is the P-polarized light passes through the optical functional film and is guided to the liquid crystal panel 35B, disposed to oppose the second surface 33S2 of the PBS 33, via the quarter wavelength plate 34B. The green light G and the blue light B that are the S-polarized light are reflected by the optical functional film and are guided to the liquid crystal panel 35A, disposed to oppose the third surface 33S3 of the PBS 33, via the quarter wavelength plate 34A.

The red light R having transmitted through the optical functional film of the PBS 33 is corrected in terms of the polarization state by the quarter wavelength plate 34B, and then modulated by the liquid crystal panel 35B on the basis of the picture signal. The red light R modulated by the liquid crystal panel 35B is corrected again in terms of the polarization state by the quarter wavelength plate 34B, and then outputted toward the PBS 33. The red light R having entered the PBS 33 is reflected by the optical functional film and outputted from the fourth surface 33S4 toward the wavelength selective polarization rotator 36. The green light G and the blue light B reflected by the optical functional film of the PBS 33 are each corrected in terms of the polarization state by the quarter wavelength plate 34B and then modulated by the liquid crystal panel 35A on the basis of the picture signal. The green light G and the blue light B modulated by the liquid crystal panel 35A are each corrected again in terms of the polarization state by the quarter wavelength plate 34A and then outputted toward the PBS 33. The green light G and the blue light B having entered the PBS 33 are each transmitted through the optical functional film and outputted from the fourth surface 33S4 toward the wavelength selective polarization rotator 36.

The wavelength selective polarization rotator 36 transmits the S-polarized red light R out of the red light R, the green light G, and the blue light B that have entered from the PBS 33 as it is, and converts the P-polarized green light G and the blue light B into the P-polarized light. The red light R, the green light G, and the blue light B having been transmitted through the wavelength selective polarization rotator 36 are outputted toward the projection optical system 40 with their polarization directions being adjusted by the polarizing plate 37.

### [Workings and Effects]

In the light source module 10 of the present embodiment, in the wavelength conversion unit 12 having the phosphor region 120A that absorbs the excitation light EL and outputs the fluorescence FL (the yellow light Y) and the reflection region 120B that reflects the excitation light EL and outputs the excitation light EL as the blue light B, the quarter wavelength plate 124 is selectively disposed in the reflection region 120B. Thus, the excitation light EL included in the yellow light Y is reflected by the polarization separation dichroic mirror 14 toward, for example, the light source unit 11. This will be described below.

In recent years, a small-sized and high-luminance projector has been demanded. In order to achieve the small-sized and high-luminance projector, it is important to develop an optical configuration having an excellent light utilization efficiency. As a method of a projector that performs full-color displaying, there are, for example, a single-plate method using one light valve that is common to the respective pieces of color light of R, G, and B, a three-plate method using separate light valves for the three pieces of color light, and the like. However, in the three-plate projector, it is generally difficult to achieve miniaturization. On the other hand, although the projector of the single plate type is advantageous for miniaturization, it is difficult to increase the luminance due to the limitation of the light emission time of each color because the projector is generally of a time sequential type. In order to achieve both high luminance and the miniaturization, in a case where the single plate system and a phosphor light source suitable for high luminance are combined, unused light increases and discarded light is generated, which is disadvantageous in terms of the light utilization efficiency. Therefore, a two-plate projector is being developed.

In the two-plate projector, a light source module 1000 as illustrated in FIG. 7, for example, is used as a light source. The light source module 1000 includes, for example: a light source unit 1100; a reflective segmentation phosphor wheel 1200; and a condenser lens 1300 a polarization separation dichroic mirror 1400, and a quarter wavelength plate 1500 that are disposed between the light source module 100 and the phosphor wheel 1200. In the reflective segmentation phosphor wheel 1200, as illustrated in FIG. 8, for example, respective pieces of color light (the yellow light Y and the blue light B) are supplied to an illumination optical system in a time-sequential manner from two regions of yellow and blue.

However, in the reflective segmentation phosphor wheel 1200, as illustrated in FIG. 9, for example, a phenomenon in which blue light B′ is mixed in the yellow light Y due to a surface reflection of the phosphor wheel or a scattering phenomenon caused by phosphor particles occurs. This blue light B′ has the same optical path as the yellow light Y, and has the same wavelength and the same polarization as the blue light B at the time of the blue light, so that it is difficult to separate the blue light.

Mixing of the blue light with the yellow light, including the red light and the green light, leads to a reduction in color gamut. In particular, due to a relationship of visibility, an influence of the blue light mixed with the red light is more than twice as large as the influence of the blue light mixed with the green light, so that the color gamut is greatly reduced and color reproducibility is greatly reduced.

In contrast, in the present embodiment, in the wavelength conversion unit 12 having the phosphor region 120A that absorbs the excitation light EL and outputs the fluorescence FL (the yellow light Y) and the reflection region 120B that reflects the excitation light EL and outputs the excitation light EL as the blue light B, the quarter wavelength plate 124 is selectively disposed in the reflection region 120B. The excitation light EL that is applied to the reflection region 120B and mainly contains, for example, the S-polarized light is converted into the P-polarized light by the quarter wavelength plate 124 to be outputted, whereas the excitation light EL applied to the phosphor region 120A and not absorbed by the phosphor particles are outputted together with the fluorescence FL while being the S-polarized light. Thus, for example, in order to reflect the excitation light EL outputted from the light source unit 11 toward the wavelength conversion unit 12, the excitation light EL included in the yellow light Y is reflected toward the light source unit 11 by the polarization separation dichroic mirror 14 disposed at a position opposed to the light source unit 11, for example. That is, the blue light B included in the yellow light Y is separated.

As described above, in the light source module 10 of the present embodiment, as compared with the light source module 1000 used for the typical two-plate type projector, for example, as illustrated in FIG. 7, the blue light component to be mixed with the yellow light component is eliminated in principle, so that it is possible to enlarge the color gamut of the projector 1 including the same.

In the present embodiment, for example, the quarter wavelength plate film 124X may be used instead of the plate-shaped quarter wavelength plate 124 having a predetermined thickness as described above. As a result, it is possible to reduce the number of components to be attached to or coated on the wheel substrate 121, and to reduce a cost. Further, because the rotational balance of the wheel substrate 121 is improved as compared with a case where the polarization maintaining and diffusing plate 123 and the quarter wavelength plate 124 are laminated on the front surface 121S1 of the wheel substrate 121, it is possible to improve the flicker.

Further, in the present embodiment, as described above, the polarization maintaining and diffusing plate 123 may be embedded in the wheel substrate 121, the polarization maintaining and diffusing plate 123 may be disposed in a plane of the wheel substrate 121, and the quarter wavelength plate 124 or the quarter wavelength plate film 124X may be attached to a surface thereof. As a result, it is possible to further improve the rotational balance of the wheel substrate 121, and to further improve the flicker.

Furthermore, in the present embodiment, as described above, for example, the quarter wavelength plate 124 having an outer shape including a straight line may be partially provided in a range including the illumination trajectory of the excitation light EL in the reflection region 120B. Thus, it is possible to reduce a material cost and a processing cost.

Further, in the present embodiment, as described above, the reflection region 120B may be divided into the plurality of sections with respect to the rotational direction of the wheel substrate 121, and the quarter wavelength plates 124A, 124B, 124C, and so forth having a uniform slow axis in the plane may be respectively provided for the respective sections. As a result, for example, as compared with a case of using the quarter wavelength plate 124 having a non-uniform slow axis in the plane having a slow axis of an angle of approximately 45° in any radial axis J121B in a plane, it is possible to reduce the manufacturing cost while maintaining the polarization conversion efficiency of the excitation light EL.

Next, a first modification example to a third modification example according to an embodiment of the present disclosure will be described. Hereinafter, the same components as those in the above-described embodiment are denoted by the same reference numerals, and the element thereof will be omitted as appropriate.

### 2. Modification Examples

### 2-1. First Modification Example

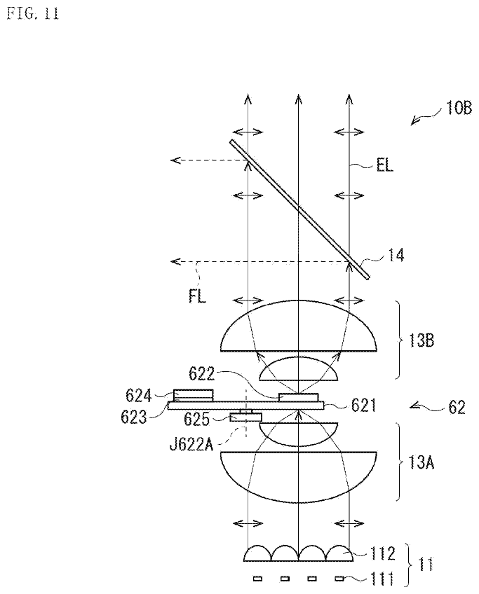

FIG. 10 illustrates a configuration example of a light source module 10A according to a first modification example of the present disclosure. In the above embodiment, a configuration of arrangement is employed in which the excitation light EL to be outputted from the light source unit 11 and the fluorescence FL to be outputted from the wavelength conversion unit 12, for example, are orthogonal to each other in the polarization separation dichroic mirror 14, but it is not limited thereto. The present modification example differs from the above-described embodiment in that, as illustrated in FIG. 10, the light source unit 11 and the wavelength conversion unit 12 are arranged on a straight line so as to oppose each other.

The light source module 10A of the present modification example uses, for example, the light source unit 11 that outputs blue light (B) mainly containing the P-polarized light as the excitation light EL, and the polarization separation dichroic mirror 14 that selectively transmits blue light (B) of the P-polarized light. In the light source module 10A, the fluorescence FL outputted from the phosphor region 120A of the wavelength conversion unit 12 and the excitation light EL outputted from the reflection region 120B are reflected by the polarization separation dichroic mirror 14, and the excitation light EL outputted from the phosphor region 120A of the wavelength conversion unit 12 passes through the polarization separation dichroic mirror 14 and returns to the light source unit 11.

As described above, in the present modification example, because the light source unit 11 and the wavelength conversion unit 12 are disposed on a straight line, cooling of the light source unit 11 and the wavelength conversion unit 12 is facilitated as compared with the light source module 10 of the above-described embodiment. Therefore, it is possible to reduce an occurrence of noise in a picture to be projected by the projector including the same. Further, it is possible to achieve a smaller-sized light source module 10A and the projector including the same.

### 2-2. Second Modification Example

FIG. 11 illustrates a configuration example of a light source module 10B according to a second modification example of the present disclosure. In the above-described embodiment, an example in which the reflection-type wavelength conversion unit 12 is used has been described, but it is not limited thereto, and the present technology is also applicable to a transmission-type wavelength conversion unit 62.

The light source module 10B includes, for example, the light source unit 11, the wavelength conversion unit 62, condenser lenses 13A and 13B, the polarization separation dichroic mirror 14, and a half wavelength plate 624 selectively disposed in a predetermined region of the wavelength conversion unit 62.

The wavelength conversion unit 62 is a so-called transmission-type wavelength conversion device, and is configured such that the fluorescence FL generated by the incidence of the excitation light EL is outputted from a side that is on an opposite side of the incidence side of the excitation light EL. The wavelength conversion unit 62 includes, for example, a wheel substrate 621, a phosphor layer 622, a transmission-type polarization maintaining and diffusing plate 623, and a half wavelength plate 624.

The wheel substrate 621 is for supporting the phosphor layer 622, the polarization maintaining and diffusing plate 623, and the half wavelength plate 624. The wheel substrate 621 is, for example, a plate-shaped member having a pair of opposing surfaces (a front surface 621S1 and a back surface 621S2) and having a light transmissive property, and has, for example, a disk shape.

As with the phosphor layer 122 described above, the phosphor layer 622 includes a plurality of phosphor particles, and is excited by the excitation light EL to emit light (the fluorescence FL) in a wavelength band different from the wavelength band of the excitation light EL. The phosphor layer 622 is formed in a plate shape by, for example, a so-called ceramic phosphor or a binder-type phosphor. The phosphor layer 622 is provided, for example, in a phosphor region on the front surface 621S1 of the wheel substrate 621. The phosphor layer 622 includes, for example, phosphor particles excited by, for example, the blue light B outputted from the light source unit 11 and emit light (the yellow light Y) in a wavelength band corresponding to yellow. Such phosphor particles include, for example, YAG (yttrium-aluminum-garnet) based material. The phosphor layer 622 may further include semiconductor nanoparticles such as quantum dots, organic dyes, or the like.

The polarization maintaining and diffusing plate 623 corresponds to a specific example of a “light diffusion structure” of the present disclosure. The polarization maintaining and diffusing plate 623 has no polarization effect on light of a predetermined wavelength band (for example, the blue light B) and has a diffusion effect. Thus, in the present modification example, the excitation light EL that is the blue light B is outputted from the wavelength conversion unit 62 as a portion of the illumination light. The polarization maintaining and diffusing plate 623 is provided in a reflection region on the front surface 621S1 of the wheel substrate 621, for example, in a fan shape corresponding to the shape of the reflection region, or is partially provided in a range including an illumination trajectory of the excitation light EL.

The half wavelength plate 624 corresponds to a specific example of a “phase difference element” of the present disclosure. The half wavelength plate 624 rotates a polarization direction of linearly polarized light and outputs the light, and is, for example, laminated on the polarization maintaining and diffusing plate 623 as illustrated in FIG. 1. Thus, in the present modification example, only the excitation light EL applied to the reflection region of the excitation light EL having entered the wavelength conversion unit 62 is selectively polarized-converted and outputted toward the illumination optical system 20.

Each of the condenser lens 13A and 13B is configured by one or a plurality of lenses. In the present modification example, as in the first modification example, for example, the light source unit 11 that outputs the blue light (B) mainly containing the P-polarized light as the excitation light EL is used, the light source unit 11 is disposed on the back surface 621S2 side of the wheel substrate 621, and the condenser lens 13A is disposed between the light source unit 11 and the wavelength conversion unit 62. The condenser lens 13A condenses the excitation light EL to a predetermined spot diameter and causes the excitation light EL to enter the wavelength conversion unit 62. The condenser lens 13B is disposed between the wavelength conversion unit 62 and the polarization separation dichroic mirror 14 disposed on the front surface 621S1 side of the wheel substrate 621. The condenser lens 13B converts the fluorescence FL outputted from the wavelength conversion unit 62 into collimated light and guides the collimated light to the polarization separation dichroic mirror 14. The polarization separation dichroic mirror 14 of the present modification example selectively transmits, for example, the P-polarized blue light (B) as in the first modification example.

In the light source module 10B, the excitation light EL enters from the back surface 621S2 side of the wheel substrate 621. Out of the excitation light EL that has entered from the back surface 621S2 side of the wheel substrate 621, the excitation light EL applied to the phosphor region excites the phosphor particles in the phosphor layer 622. In the phosphor layer 622, the phosphor particles are excited by the application of the excitation light EL, and the fluorescence FL is outputted toward the condenser lens 13B. Out of the excitation light EL having entered from the back surface 621S2 side of the wheel substrate 621, the excitation light EL applied to the reflection region 620B is diffused while maintaining the polarization direction in the polarization maintaining and diffusing plate 623, and is converted in terms of the polarization direction from the P-polarized light to the S-polarized light in the half wavelength plate 624 and outputted toward the condenser lens 13. The fluorescence FL outputted from the phosphor region of the wavelength conversion unit 12 outputted from the wavelength conversion unit 62 and the excitation light EL outputted from the reflection region are reflected by the polarization separation dichroic mirror 14. The excitation light EL outputted from the phosphor region of the wavelength conversion unit 12 passes through the polarization separation dichroic mirror 14. As a result, the blue light component to be mixed with the yellow light component is eliminated in principle. Therefore, as in the above-described embodiment, it is possible to enlarge the color gamut of the projector including the same.

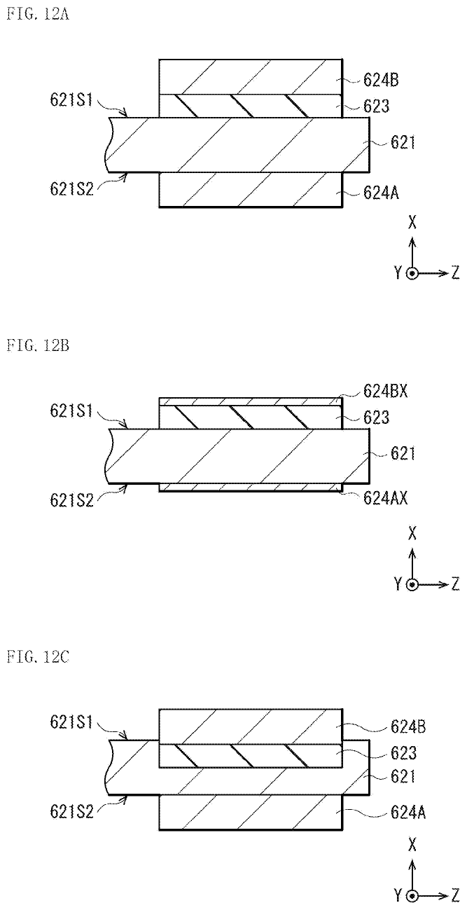

Note that, in the present modification example, an example in which the half wavelength plate 614 is used as the “phase difference element” of the present disclosure has been described, but a quarter wavelength plate may be used, for example, as in the above-described embodiment. In this case, as illustrated in FIG. 12A, for example, quarter wavelength plates 624A and 624B are disposed respectively on the back surface 621S2 side and the front surface 621S1 side of the wheel substrate 621.

The half wavelength plate 624 and the quarter wavelength plates 624A and 624B may use, for example, quarter wavelength plates 624AX and 624BX, as illustrated in FIG. 12B, for example, as in the above-described embodiment. Further, as in the above-described embodiment, for example, as illustrated in FIG. 12C, the polarization maintaining and diffusing plate 623 may be embedded in the wheel substrate 621.

In addition, in the half wavelength plate 624 and the quarter wavelength plates 624A and 624B, as in the above-described embodiment, the reflection region may be divided into a plurality of sections with respect to the rotational direction of the wheel substrate 621, and a wavelength plate having a uniform slow axis in a plane perpendicular to the optical axis of the excitation light EL may be provided for each of the sections.

In any case, it is possible to obtain effects similar to those of the above-described embodiment.

### 2-3. Third Modification Example

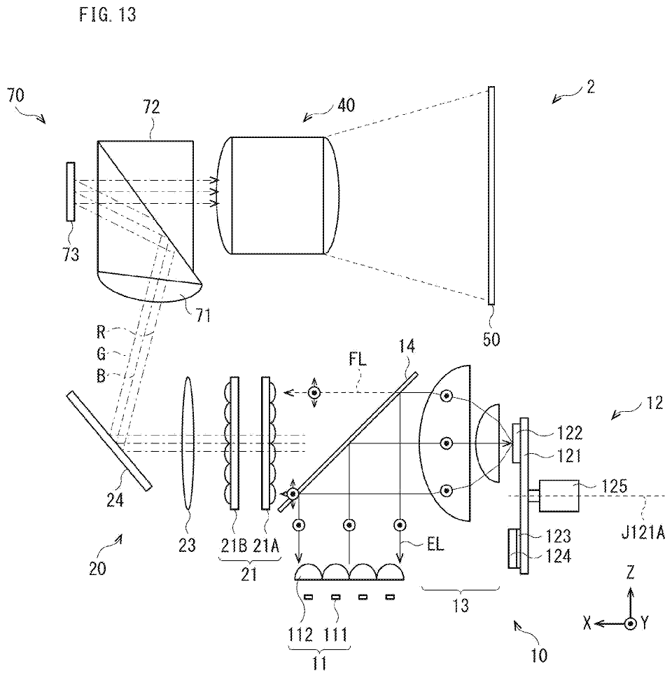

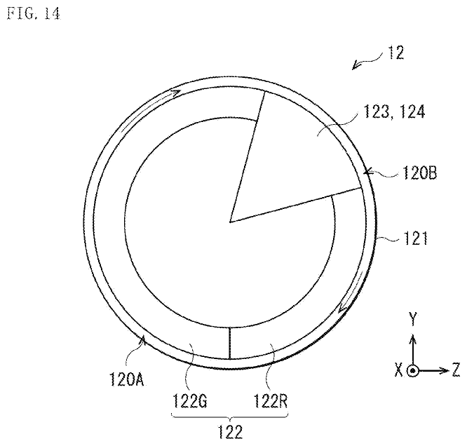

FIG. 13 illustrates a configuration example of a projector 2 according to a third modification example of the present disclosure. In the above-described embodiment, the reflection-type 2LCD scheme projection-type display device using the two reflective liquid crystal panels as light modulation elements has been described, but it is not limited thereto. The present technology is also applicable to, for example, a projector 2 using a digital micromirror device (DMD) as the light modulation element.

The projector 2 is a projector that performs light modulation by one reflective DMD. The projector 2 includes, for example, the light source module 10, the illumination optical system 20, an image forming unit 70, and the projection optical system 40.

The light source module 10, the illumination optical system 20, and the projection optical system 40 have similar configurations as those of the projector 1 described above. Specifically, the light source module 10 includes, for example, the light source unit 11, the wavelength conversion unit 12, the condenser lens 13, the polarization separation dichroic mirror 14, and the quarter wavelength plate 124 selectively disposed in a predetermined region of the wavelength conversion unit 12. The illumination optical system 20 includes, for example, the lens array 21, the relay lens 23, and the reflection mirror 24. The projection optical system 40 includes, for example, one or a plurality of lenses.

In the present modification example, the phosphor layer 122 of the wavelength conversion unit 12 includes, for example, a red phosphor region 122R that outputs the red light R and a green phosphor region 122G that outputs the green light G, as illustrated in FIG. 14. In the wavelength conversion unit 12, by rotating the wheel substrate 121, a time-averaged white light derived from temporal repetitions of red, green, blue, red, green, blue, and so forth is outputted as the illumination light.

The image forming unit 70 includes, for example, a condenser lens 71, a total internal-reflection prism (TIR prism) 72, and a DMD 73.

The condenser lens 71 has a function of uniformly illuminating the illumination light in the DMD 73. Light having entered the TIR prism 72 is reflected at an air gap surface in the prism and outputted toward the DMD 73. The DMD 73 has minute mirror elements corresponding to the number of pixels. Each mirror element is pivotable about an axis of rotation by a predetermined angle.

Although embodiments and first to third modification examples have been described above, the present disclosure is not limited to the above-described embodiments and the like, and various modifications are possible. For example, the arrangement and the number of the constituent elements of the optical system exemplified in the above-described embodiments and the like are merely examples, and it is not necessary to include all the constituent elements, and other constituent elements may be further included.

Further, the light source module 10 of the present disclosure is usable in an apparatus other than a projector. For example, the light source module 10 of the present disclosure may be used as a lighting application, and is applicable to, for example, a headlamp of an automobile or a light source for light-up.

It is to be noted that the effects described in the present specification are mere examples and description thereof is non-limiting. Other effects may be also provided.

The present technology may have the following configurations. According to the present technology having the following configurations, in a wavelength conversion unit having a phosphor region that absorbs excitation light and outputs fluorescence as first light, and a reflection region that reflects the excitation light and outputs the excitation light as second light, a phase difference element that rotates a polarization direction of the excitation light is selectively disposed in the reflection region, and the excitation light included in the first light is separated by a wavelength selective polarization separation element. Therefore, it is possible to enlarge a color gamut.

(1)

A light source module including:
a light source unit that outputs excitation light;
a wavelength conversion unit having a phosphor region and a reflection region, the phosphor region absorbing the excitation light and outputting, as first light, fluorescence that includes light in a wavelength band different from a wavelength band of the excitation light, the reflection region reflecting the excitation light and outputting the excitation light as second light;
a wavelength selective polarization separation element that separates light in a predetermined wavelength band on the basis of a polarization direction; and
a phase difference element that is selectively disposed in the reflection region and rotates a polarization direction of the excitation light.
   (2)

The light source module according to (1), wherein the light source unit outputs S-polarized light or P-polarized light.

(3)

The light source module according to (1) or (2), wherein the wavelength conversion unit includes:
a wheel substrate having a first surface and a second surface that are opposed to each other and rotatable about a rotation axis;
a phosphor layer including a plurality of phosphor particles and provided on the first surface of the phosphor region; and
a light diffusion structure provided on the first surface of the reflection region.
   (4)
The light source module according to (3), wherein
the wavelength conversion unit further includes a polarization maintaining and diffusing plate as the light diffusion structure, and
the phase difference element is disposed on the first surface with the polarization maintaining and diffusing plate interposed therebetween.
   (5)

The light source module according to (4), wherein the polarization maintaining and diffusing plate is embedded in the wheel substrate.

(6)

The light source module according to (4) or (5), wherein the phase difference element includes a plate-shaped quarter wavelength plate or a film-shaped quarter wavelength plate.

(7)

The light source module according to any one of (3) to (5), wherein the wheel substrate has a light transmissive property.

(8)

The light source module according to (7), wherein the phase difference element includes a plate-shaped quarter wavelength plate or a film-shaped quarter wavelength plate, and is provided on each of the first surface and the second surface of the reflection region.

(9)

The light source module according to (7), wherein the phase difference element includes a plate-shaped half wavelength plate or a film-shaped half wavelength plate, and is provided on the first surface or the second surface of the reflection region.

(10)

The light source module according to any one of (1) to (9), wherein the phase difference element is partially provided to include, in the reflection region, an illumination trajectory of the excitation light to be applied to the wavelength conversion unit.

(11)

The light source module according to any one of (3) to (10), wherein the phase difference element has a non-uniform slow axis in a plane perpendicular to an optical axis of the excitation light.

(12)

The light source module according to (11), wherein the slow axis has an angle of substantially 45° with respect to a radial axis about the rotation axis in a plane of the wheel substrate.

(13)

The light source module according to any one of (3) to (11), wherein the reflection region is divided into a plurality of sections in a rotational direction of the wheel substrate, and the phase difference element has a uniform slow axis in a plane for each of the sections in a plane perpendicular to an optical axis of the excitation light.
(14)

The light source module according to any one of (6) to (13), wherein the wavelength selective polarization separation element is disposed between the light source unit and the wavelength conversion unit.

15)

The light source module according to any one of (7) to 14), wherein
the light source unit is disposed on the second surface side of the wheel substrate, and
the light source unit, the wavelength conversion unit, and the wavelength selective polarization separation element are disposed in this order.
   (16)

A projector including a light source module, the light source module including:
a light source unit that outputs excitation light;
a wavelength conversion unit having a phosphor region and a reflection region, the phosphor region absorbing the excitation light and outputting, as first light, fluorescence that includes light in a wavelength band different from a wavelength band of the excitation light, the reflection region reflecting the excitation light and outputting the excitation light as second light;
a wavelength selective polarization separation element that separates light in a predetermined wavelength band on the basis of a polarization direction; and
a phase difference element that is selectively disposed in the reflection region and rotates a polarization direction of the excitation light.

The present application claims the benefit of Japanese Priority Patent Application JP2021-094748 filed with the Japan Patent Office on Jun. 4, 2021, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof. claimed is:

1. A light source module, comprising:
a light source unit that outputs excitation light;
a wavelength conversion unit having a phosphor region and a reflection region, the phosphor region absorbing the excitation light and outputting, as first light, fluorescence that includes light in a wavelength band different from a wavelength band of the excitation light, the reflection region reflecting the excitation light and outputting the excitation light as second light;
a wavelength selective polarization separation element that separates light in a predetermined wavelength band on a basis of a polarization direction; and
a phase difference element that is selectively disposed in the reflection region and rotates a polarization direction of the excitation light.

2. The light source module according to claim 1, wherein the light source unit outputs S-polarized light or P-polarized light.

3. The light source module according to claim 1, wherein the wavelength conversion unit includes:
a wheel substrate having a first surface and a second surface that are opposed to each other and rotatable about a rotation axis;
a phosphor layer including a plurality of phosphor particles and provided on the first surface of the phosphor region; and
a light diffusion structure provided on the first surface of the reflection region.

4. The light source module according to claim 3, wherein
the wavelength conversion unit further includes a polarization maintaining and diffusing plate as the light diffusion structure, and
the phase difference element is disposed on the first surface with the polarization maintaining and diffusing plate interposed therebetween.

5. The light source module according to claim 4, wherein the polarization maintaining and diffusing plate is embedded in the wheel substrate.

6. The light source module according to claim 4, wherein the phase difference element comprises a plate-shaped quarter wavelength plate or a film-shaped quarter wavelength plate.

7. The light source module according to claim 3, wherein the wheel substrate has a light transmissive property.

8. The light source module according to claim 7, wherein the phase difference element comprises a plate-shaped quarter wavelength plate or a film-shaped quarter wavelength plate, and is provided on each of the first surface and the second surface of the reflection region.

9. The light source module according to claim 7, wherein the phase difference element comprises a plate-shaped half wavelength plate or a film-shaped half wavelength plate, and is provided on the first surface or the second surface of the reflection region.

10. The light source module according to claim 1, wherein the phase difference element is partially provided to include, in the reflection region, an illumination trajectory of the excitation light to be applied to the wavelength conversion unit.

11. The light source module according to claim 3, wherein the phase difference element has a non-uniform slow axis in a plane perpendicular to an optical axis of the excitation light.

12. The light source module according to claim 11, wherein the slow axis has an angle of substantially 45° with respect to a radial axis about the rotation axis in a plane of the wheel substrate.

13. The light source module according to claim 3, wherein
the reflection region is divided into a plurality of sections in a rotational direction of the wheel substrate, and
the phase difference element has a uniform slow axis in a plane for each of the sections in a plane perpendicular to an optical axis of the excitation light.

14. The light source module according to claim 6, wherein the wavelength selective polarization separation element is disposed between the light source unit and the wavelength conversion unit.

15. The light source module according to claim 7, wherein
the light source unit is disposed on the second surface side of the wheel substrate, and
the light source unit, the wavelength conversion unit, and the wavelength selective polarization separation element are disposed in this order.

16. A projector including a light source module, the light source module comprising:
a light source unit that outputs excitation light;
a wavelength conversion unit having a phosphor region and a reflection region, the phosphor region absorbing the excitation light and outputting, as first light, fluorescence that includes light in a wavelength band different from a wavelength band of the excitation light, the reflection region reflecting the excitation light and outputting the excitation light as second light;
a wavelength selective polarization separation element that separates light in a predetermined wavelength band on a basis of a polarization direction; and
a phase difference element that is selectively disposed in the reflection region and rotates a polarization direction of the excitation light.
